(19) United States
(12) Patent Application Publication
(10) Pub. No.: US 2010/0036697 A1
(43) Pub. Date: Feb. 11, 2010

(54) Online Management of the Provision of Advice and Services

(75) Inventor: David John Samuel Kelnar, Edinburgh (GB)

Correspondence Address: GARCIA-ZAMOR INTELLECTUAL PROPERTY LAW;ATTN: RUY GARCIA-ZAMOR, 12960 LINDEN CHURCH ROAD, CLARKSVILLE, MD, 21029, US

(73) Assignee: Greatvine Limited, London (GB)

(21) Appl. No.: 12/539,418

(22) Filed: Aug. 11, 2009

(30) Foreign Application Priority Data
Aug. 11, 2008 (GB) 0814605.2

(51) Int. Cl. G06Q 30/00; G06Q 10/00

(52) U.S. Cl. 705/7; 705/26; 705/27

(57) ABSTRACT

A method and system for the management of the provision of advice and services and in particular to consultancy services managed and provided via the Internet or any other public Internet type network. The method comprises the steps of receiving requests from a plurality of participants including an advice provider and at least one user for access to a conferencing event. The identity of each participant is checked and a conferencing space is established in which each participant is able to communicate with each other participant. The charge for the conferencing event is debited from prearranged users' accounts.

### BACKGROUND

The present invention relates to the online management of the provision of advice and services and particularly, but not exclusively, to consultancy services managed and provided via the internet or any other public internet-type network.

2. Technical Field of the Invention

An individual searching the internet for advice or information faces a plethora of websites promoting information from, and the services of, individuals and companies. The enormous volume of information and promotional material now available online has resulted in the development of sophisticated search engines, such as Google™, to help users locate the information they require. However, even using highly-developed search engines, an individual searching for help or advice—for example, regarding parenting—will be presented with a very large number of potentially relevant websites with no means of determining the quality of the advice or services on offer. Moreover, information provided by most websites is extremely superficial in nature and of limited value in addressing real-life problems such as “How can I help my six-month old child sleep through the night?” or “I'd like to open a restaurant. How can I write a business plan and successfully raise the capital I need?”

Furthermore, most websites are used as little more than virtual advertisements; once someone has found a website which appears to offer relevant advice or assistance, he/she may then only contact the individual or organisation advertising on that website by other means such as email. Subsequent and ongoing communication between the individual and the party behind the website also remains wholly separate from the website. While some companies' websites do include gateways which can be used, for example, to monitor the progress of an ongoing project, such gateways are accessible only to the companies' existing customers.

2. Description of Related Art

US2006/0247959 describes an internet portal for professional services organisations (PSOs) allowing individuals to easily search for and find consultants; schedule and access their consultancy services directly using telephonic or web-based conferencing; and undertake associated ‘fulfilment’ including payment and the provision of feedback. In essence, this document describes a virtual framework for consultancy services delivered on what is described as a ‘just-in-time’ model with billing based upon fulfilment of pre-agreed stages of a Statement of Works.

### SUMMARY OF THE INVENTION

The present invention seeks to address the problems and limitations presented by conventional internet services.

Thus, the present invention provides an online management method for the provision of advice and services, the method comprising the steps of: receiving requests from a plurality of participants including an advice provider and at least one user for access to a conferencing event in which the advice provider is to provide advice, services, or advice and services to the at least one user in return for a fee; receiving from the at least one user a user specified maximum fee; calculating automatically a maximum time duration the advice provider should participate in the conferencing event on the basis of the user specified maximum fee and the advice provider's predetermined cost per unit time; checking the identity of each participant; establishing a conferencing space in which each participant is able to communicate with each other participant and communicating the calculated maximum time to each participant; and thereafter automatically debiting from at least one of the at least one users using a pre-arranged account a charge for the conferencing event, wherein the charge is based upon the time duration of the advice provider's participation in the conferencing event, the charge not exceeding the user specified maximum fee in the absence of consent from the user to an increase.

In a preferred embodiment the method further includes the step of method of adjusting the advice provider's predetermined cost per unit time based upon at least one of: the communication medium used for the conferencing event, the topic of the conferencing event, and the status of the at least one user.

The topic can be used to adjust the advise provider's cost per unit time, such that for example the advise provider's level of expertise or qualifications in a particular topic effect the cost per unit time. When used herein, the status of a user is meant to encompass any quality of the user which may impact on the cost to the user of receiving advice. For example, the user may be a member of a particular organisation, such as but not limited to a health insurance company which may offer discounted advice to members. In another non-limiting example, the user's status may be altered based on their financial status, such that a user on a lower than average income can receive advice and/or support at a lower than average cost per unit time. It is also envisaged that a combination of these factors and others can be used to determine the user's status which in turn can be used to adjust the advice provider's cost per unit time. The advice provider can set their cost per unit time to zero in order to provide free advice.

Preferably, the management method further comprises the step of recording at least one or more of audio, video and other interactions which take place during the conferencing event and providing at least one participant with access to the recording such that the at least one participant can access the recording after the conferencing event. It is envisaged that the management method can further comprise the step of separately monitoring the duration of the advice provider's and the user's participation in a conferencing event and determining the charge for the user on the basis of the simultaneous participation of the advice provider and the user in the conferencing event.

Preferable as part of the management method, during a conferencing event involving more than one user, the duration of each user's participation in the conferencing event is separately recorded and a charge for each individual user is determined on the basis of the duration of the simultaneous participation of the advice provider and the individual user and billed to the individual user's pre-arranged account.

Preferably the management method further comprises the step of allocating a conferencing slot in response to a request from at least one of the participants, wherein the step of allocating a conferencing slot is adapted to enable mutual agreement between the participants of one or more of a time for commencement of the conferencing slot, a topic for the conferencing slot, and the fee for the conferencing slot.

In one embodiment, a payment is rendered to the advice provider based upon the total charges debited from the at least one users' pre-arranged accounts less an administrative charge retained by the conference space provider.

Preferably, the management method comprises the exchange of one or more messages between the advice provider and the one or more users and automatic debiting, from the user's pre-arranged account, a charge for the exchange of one or more messages wherein the charge is either calculated on the basis of the advice provider's predetermined cost per unit time and time duration for the preparation of each message issued by the advice provider or is a calculated on the basis of a fixed fee for each message.

It is envisaged the management method further comprises the steps of enabling the downloading of material in the form of documents or other media and automatically debiting from a user's pre-arranged account a charge for the downloaded material.

Preferably, only a pre-approved advice provider is allowed to participate in the conferencing event. In one non-limiting example, the advice provider is only allowed use the management method if the are invited to do so. In another non-limiting example, it is envisaged that an advice provider who has received an invite to use the management method is only allowed to participated in particular conferencing events where, for example, their level of expertise in the topic of the conferencing event is above a predetermined threshold.

More preferably, an advice provider is allowed to compare their cost per unit time fee with another advice provider's cost per unit time fee. The conferencing event may be accessed by telephone and/or via the internet. Also, the conferencing event may include an interactive online workspace accessible to all participants.

In a second aspect the present invention provides an online system for the provision of advice and services, the system comprising: a memory in which is stored a participant database containing details of participants to a conferencing event the participants comprising an advice provider and at least one user; a processor for calculating automatically a maximum time duration the advice provider should participate in the conference event based on a user specified maximum fee and the advice provider's predetermined cost per unit time; a conferencing server in communication with the participant database for checking the identity of each participant to the conferencing event and for establishing a conferencing space in which each participant is able to communicate with each other participant; and a billing manager adapted to automatically debit from at least one of the at least one users using a pre-arranged account a charge for the conferencing event, the charge being based upon the time duration of the advice provider's participation in the conferencing event and the charge not exceeding the user specified maximum fee in the absence of consent from the user to an increase.

Preferably, the advice provider's predetermined cost per unit time varies with respect to at least one of: the communication medium used for the conferencing event, the topic of the conferencing event, and the status of the at least one user, as discussed above in relation to the management method.

More preferably, the online system, further comprises a display driver for generating image data for displaying to the participants, the image data including the calculated maximum time duration the advice provider should participate in the conferencing event.

It is envisaged that the online system further comprises a recorder adapted to record one or more of audio, video and other interactions which take place during a conferencing event for later access by at least one participant of the conferencing event.

Preferably, the online system further comprises a timer adapted to separately monitor the duration of the advice provider's and the user's participation in a conferencing event whereby the billing manager determines a charge for the user on the basis of the simultaneous participation of the advice provider and the user in the conferencing event.

More preferably, the online system further comprises a timer adapted to separately monitor the duration of each user's participation in a conferencing event involving more than one user wherein a charge for each individual user is determined on the basis of the duration of the simultaneous participation of the advice provider and the individual user and billed to the individual user's pre-arranged account.

It is envisaged that the online system may further comprise an appointments manager for allocating a conferencing slot in response to a request from at least one of the participants, the appointments manager being adapted to enable mutual agreement between the participants of one or more of a time for commencement of the conferencing slot, a topic for the conferencing slot, and the fee for the conferencing event. It is also envisaged that the online system may include a message manager adapted to enable message exchange between the advice provider and the one or more users, wherein the billing manager is adapted to automatically debit from the user's pre-arranged account a charge for the message exchange.

Preferably, the online system further includes a document manager adapted to enable the downloading of material in the form of documents or other media and wherein the billing manager is adapted to automatically debiting from a user's pre-arranged account a charge for the downloaded material.

The conferencing server may be adapted to be accessed by participants by telephone and/or via the internet. Also the conferencing server may be adapted to provide an interactive online workspace accessible to all participants.

Ideally, the billing manager is further adapted to render a payment automatically to the advice provider based upon the charge debited from the at least one user's pre-arranged account.

The present invention provides a management system for the online provision of advice and services, which enables members of the public to receive advice and information, in real-time, from highly respected, hand-selected experts in a range of topics. Topics which may be covered include, but are not limited to, Education, Parenting, Careers, Law, Small

Business Development, Health & Wellbeing, Skills (including Writing and Technology) and Finance. The management system enables consumers to browse a directory of independent experts and undertake a live, one-on-one conversation with a chosen expert—by telephone or online—based on a pre-agreed charging regime.

The system also includes the functionality for: enabling live telephone- or web-based discussions in which many hundreds of users may listen to a single consultant; enabling the self-publishing of documents and files by service providers including consultants, for sale and download direct by consumers; and the provision of paid advice by asynchronous messaging rather than live speech. The system further offers automatic ‘fulfilment’, including calculations of time spent and payments due, together with the provisioning of these payments—to consultants and the administrators of the management system for one-to-one consultations, events, help via asynchronous messaging, and the downloading of materials. The system also offers numerous additional features, such as the provision of feedback regarding consultants and materials, anonymous calling for sensitive topics, and the provision of call recording and the delivery of call recordings according to parties' preferences.

At no stage does the management system require any software downloads or installations by either the users or the consultants. Thus, with the management system described herein, for the first time consumers may find a wide variety of convenient, high-quality, personalised advice and information from a single source to address their real-life questions and problems.

### BRIEF DESCRIPTION OF THE DRAWINGS

The foregoing and other objects, aspects and advantages will be better understood from the following detailed description of a preferred embodiment of the present invention with reference to the drawings, in which:

FIG. 1 illustrates schematically an overview of a consultant services management system in accordance with the present invention;

FIG. 2 is a flow diagram of the steps for performing a search of the consultant database of the management system of FIG. 1;

FIG. 3 is a flow diagram of the steps for booking and implementing a telephone-based or online consultation using the management system of FIG. 1; and

FIG. 4 is a flow diagram of the steps for operating and charging for a consultation.

### DETAILED DESCRIPTION OF THE PREFERRED EMBODIMENT

In overview, the consultant services management system described herein is accessible via the internet and functions as a single online gateway or portal to a plurality of independent consultants, advisors and other organisations offering consultancy and information services. The management system includes functionality to deliver real-time consultancy services via telephone, and online in a richly interactive environment.

Additionally, the management system includes, but is not limited to: search functionality, to enable the consultant best suited to a consumer's needs to be identified through consideration of a consultant's specialties, professional qualifications, professional experiences and other details; the categorisation and upload and pricing of high-quality written materials and media by consultants, and their subsequent download without charge or for a fee by consumers; asynchronous messaging functionality, to enable consultants to provide considered advice separately from any telephone discussions that may take place; telephone and online consultation recording, and the supply of these recordings directly to the parties; feedback functionality; and automated payment functionality.

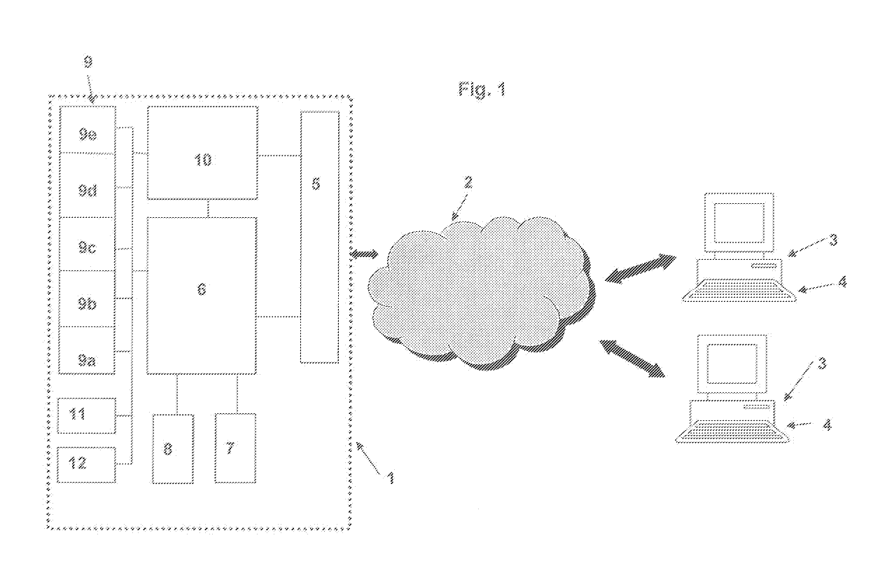

FIG. 1 illustrates the remote consultant services management system 1 which is adapted for connection via the internet 2 or any other publicly accessible network to one or more local terminals 3 (two local terminals are shown in FIG. 1) each of which includes one or more user input devices 4 such as a keyboard and/or a navigator (e.g. a mouse, touch screen etc).

The consultancy services management system 1 includes an internet interface 5 adapted to receive, via the internet, user instructions input using the input devices 4 of the local terminals 3 and adapted to output data and other content in the form of, but not limited to, text, audio, images and GUIs. The management system also includes a server 6, which comprises the main processor of the management system and which is in communication with the interface 5 and with a program memory 7, a cache 8, one or more databases 9 a communications server 10 (which is described in greater detail below), and a message manager 11 and an appointments manager 12. Each consultant and registered user of the management system 1 has an online message account and appointments calendar associated with their data stored in the database(s) 9.

The program memory 7 is adapted to store the program instructions for operation of the management system. The one or more databases 9 contain the data to be accessed by the program instructions and preferably is stored in memory. Ideally, the data is stored in the database(s) employing structured query language (SQL) or an equivalent. The cache 8 is provided to temporarily store data accessed from the database(s) 9 and may, for example, be in the form of flash memory.

The database(s) include, but are not limited to, the following data stores: a user data store 9a containing information, such as contact details and preferences, on authorised users of the management system; a consultant data store 9b containing information, such as biographical information, on each consultant offering their services via the management system; a publications data store 9c containing downloadable materials which consultants have uploaded for distribution and/or sale on the system; a user accounting store 9d containing billing and account information for each user; and a consultant accounting store 9e containing account information for each consultant.

The individual functional components of the consultancy services management system 1 may be implemented using conventional computer technology. Thus although described as discrete elements, the communications server, the appointments manager and the message manager are not required to be separate physical entities and may be implemented wholly in software. Similarly, the contents of the database(s) have been divided purely to assist in comprehension and the memory in which the data is stored is not required to be physically sub-divided in the manner described herein. Similarly, the local terminals accessing the management system may be conventional personal digital devices such as, but not limited to, personal digital assistants (PDAs) and laptop or desktop computers.

The consultant services management system 1 preferably operates on an invitation-only basis. This ensures that the quality of the consultants available through the remote management system is managed and controlled by the operator of the management system.

Each consultant provides details about himself or herself—including specialties, professional qualifications, professional experiences, publications and sample work—which are stored in the consultant data store 9b. Additionally, each consultant identifies one or more subject categories relevant to their expertise, and in which they will be available to provide consultancy services. These categories may be sub-divided into more precise sub-topics. Users may browse for independent consultants according to these sub-topics, using a series of hierarchical drop-down menus or selectable key-words. For example, a user may start by choosing a ‘high-level’ domain (such as ‘Parenting’), before narrowing the selection of available consultants to match the needs of the user by selecting a particular sub-topic (‘Helping your child’) and potentially sub-sub-topics (‘Behaviour and discipline’) via further drop-down menus or keywords which appear. This enables the user to be guided to the expertise which matches their needs.

Additional search strategies, involving the use of a search field, are available—with users populating the search field with one or more search terms, either alone or in combination with predictive suggestions based on the initial characters the user enters in the search field.

The management system may search the whole contents of the consultants' biographies for search terms, as opposed to solely the pre-defined categories and topics. This enables searches to be carried out with respect to consultants' names, qualifications and experiences as well as their specialties. The same search functionality can be used for locating: materials (documents and files) made available by consultants on the management system and available for download by users (described in greater detail below); and ‘events’ in the form of one-to-many consultations (described below). Searches for downloadable materials, performed using the search field, may search the entire contents of documents and files themselves, as opposed to solely their titles or the description of the materials submitted by the consultant.

The structure of the stored data enables the ability to associate keywords with certain individual topics and sub-topics contained in the database(s) 9.

Keywords may be stored in the database(s) 9 in association with each topic or sub-topic. The purpose of this feature is to enable the management system 1 to offer helpful suggestions for topics areas in which the user may wish to browse (based on the terms they input into the search field), even if the term submitted by the user does not happen to be present in any consultants' profiles or in the description or contents of any materials. For example, if the management system has stored in its database(s) the keyword ‘Shakespeare’ associated with the ‘A-level English’ sub-topic, even if consultants in the form of English tutors have omitted the word ‘Shakespeare’ from their profiles and even if no materials contain the term, the management system 1 can still suggest to the user—correctly—that the consultants and materials in the A-level English sub-topic are likely to be able to help them in this area.

Once a search as been performed, a list of results (in the form of one or more consultants, downloadable materials or multi-party conferencing ‘events’ available through the management system) are displayed to the user. The user may toggle between these different categories of available assistance/information via a set of buttons. Beside each consultant in the list of results, a pictorial representation (avatar) configured by the consultant is displayed, together with the consultant's per-minute fee and (if applicable) the logo of an organisation if the consultant is formally representing the organisation via the service. By selecting one of the consultants in the results list, the consultant's biography and further information about the consultant—including the publications they have made available for download—are displayed in a window of the same screen, or in a separate (pop-up) window.

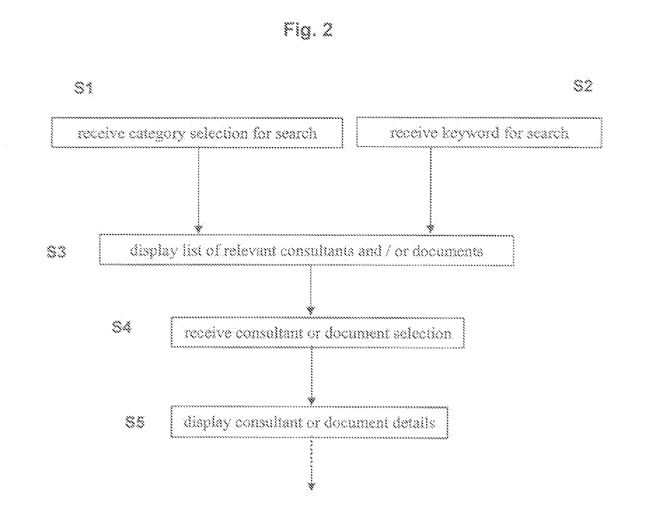

Thus, as shown in FIG. 2, the steps performed by the management system for enabling a user to locate a consultant with the relevant expertise to provide the advice or assistance the user requires are as follows: the user logs on to the management system and selects a subject category for selection which may be further refined S1. Alternatively, the user may undertake a keyword search, S2, which may also be refined (by subject category). Thereafter, the management system displays a list of consultants, downloadable materials and ‘events’ relevant to the topic and/or term being searched, S3. The management system then receives a user selection of a consultant S4, document to download or ‘event’, and the specific details of the consultant, downloadable material or ‘event’ are displayed, S5. The search functionality of the management system is similar to many search systems. A key difference is that the consultants available through the remote management system, and thus those consultants that are searchable, have been hand-picked for their expertise and experience—to ensure the quality of the consultancy services on offer.

When a user has identified a consultant with whom he wishes to interact, the management system's message manager 11 allows the user to safely exchange messages with the consultant—typically to explain his specific circumstances and check the availability of the consultant. The message manager 11 ensures neither party need disclose its personal contact details—instead, the messaging remains wholly within the management system 1. Message threads are private to the user and consultant in question and are not visible to any other party. They may also be confidential, with the name and other details of the user not be revealed to the consultant in certain circumstances.

The appointments manager 12 allow a consumer to formally schedule an appointment with a consultant which will take place within the management system, and maintains information about the availability of consultants given other consultations they may have scheduled. Thus, the appointments manager 12 maintains information regarding consultants' existing appointments, their availability for new appointments, and provides a visual calendar which displays forthcoming commitments. The appointments manager also includes functionality to enable scheduled appointments to be formally cancelled or rescheduled at the user's request.

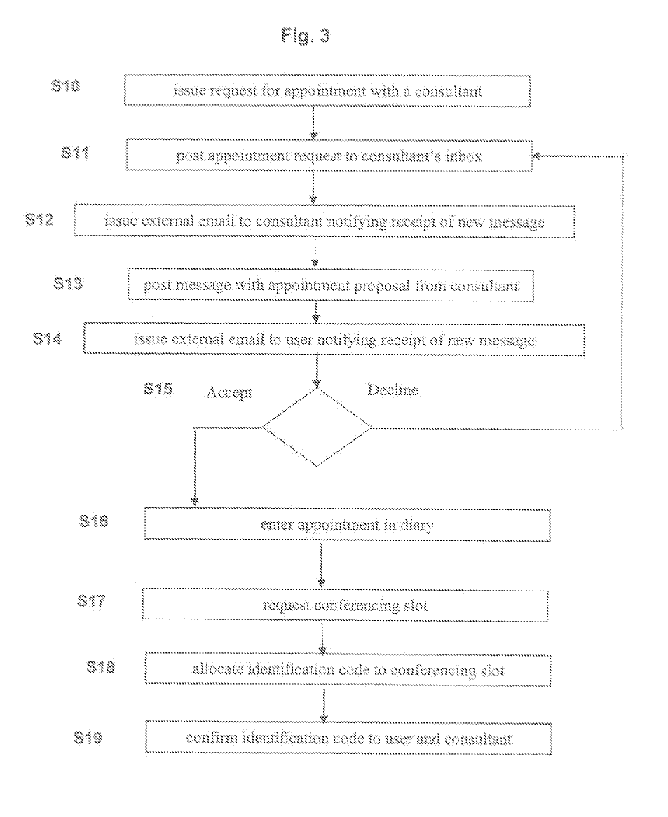

As shown in FIG. 3, a user typically expresses his desire for a consultation using the management system's messaging system, via a new message to the consultant in question S10. The user populates this message with information to describe his preferred appointment—such as: his ideal date and time for the consultation; whether the consultation should take place by telephone, online or both; the nature of the advice he wishes to receive, and any other information he feels is pertinent. The completed message is then communicated to the inbox of the selected consultant, S11 where it waits to be read by the consultant. The message manager 11 informs the user whether a message sent to a consultant has, or has yet, to be read.

The message manager 11 also generates automated emails which are sent via the interface 5 to consultants' personal external email accounts, notifying them S12 when new messages are received from users. When a consultant receives notification that a new message has been sent to them via the management system's messaging system, the consultant must log on to the management system to reply to the new user message. In addition to sending a textual reply via the message manager 11 (“I can confirm my expertise in that area, and would be pleased to help”), the management system 1 offers consultants the ability to formally propose and book telephone- or web-based appointments which take place within the management system. The consultant may—via inputs including pop-up calendars, textual entries in fields, and radio buttons—propose a precise date and time for a live consultation with the user, together with a formal proposal of the communications medium to be used (telephone, online or both) S13. In addition, if a consultant offers advice in more than one sub-topic, the message system allows the consultant to specify from an automatically-populated menu (linked to the databases 9e and 9b) the sub-topic—and therefore per-minute fee—for the consultant's time. The message manager also interacts with the appointments manager 12 to include appointment ‘collision detection’, which warns a consultant or consumer if, via a message, he is proposing or accepting an appointment which overlaps with another he has already scheduled.

Via the message manager 11, the user will then receive an email sent by the management system 1 to an external personal email account indicating the presence of a new message, and potentially its content, on the management system S14. The user may then log onto the management system to view the consultant's textual reply together with the formal proposal for an appointment and its details (date, time, medium, topic, per-minute fee). The message manager 11 allows a user, who has received a formal appointment proposal, to formally accept that proposal by clicking a button in the message S15 which interfaces with the appointments manager 12. Alternatively, the user may reply to the message with a further textual message—perhaps requesting an alternative time.

Messages may be exchanged between the parties, with the appointments manager 12 allowing multiple appointments to be suggested, until a mutually satisfactory proposal has been accepted by the user.

If an appointment proposal is accepted by a user, the appointments manager 12 automatically writes the appointment into the consultant's and user's appointments calendar S16 and requests a conferencing slot S17 within the management system's communications server 10. A slot may be requested on the telephone conferencing system, and/or on the web-based conferencing server.

In reply to the request for a conferencing slot, the communication server 10 assigns a unique identification code to a telephone-based or online conference slot S18, in addition writing other appointment details agreed between the user and the consultant (including date, time, medium, topic, and per-minute fee) into the consultant and consumer databases and/or the appointment manager 12. Confirmation of the conferencing slot and its identification code is immediately communicated back and posted by the appointments manager for both the user and the consultant S19, confirming the identification code for accessing the conferencing slot by phone or online and confirming other details associated with it (such as the consultant's per-minute fee), and the topic of discussion. It is, of course, envisaged that the management system 1 may allow for an alternative or complementary schema for the parties when arranging appointments whereby the user may formally propose an appointment in response to which the consultant may then accept, decline or propose an alternative—i.e. the system as described above but in reverse.

Any time between the scheduling of an appointment and its start, the appointments manager 12 also allows each call participant, independently, to specify whether he or she wishes the call to be recorded. To facilitate this, the appointments manager includes functionality which allows users and consultants to toggle their call recording preference for each individual appointment they have scheduled. If all parties specify the call should be recorded, a recording of the call is made and made available to each party, in a popular format (MP3 or WAV) for download from the management system 1 immediately after the consultation. If any party does not wish for the call to be recorded, no recording of the call will be made.

The management system also includes an ‘available now’ status display, for consultants who wish to indicate that they are available immediately for a consultation, as opposed to requiring users to book an appointment in advance. The management system's messaging system and appointments system include functionality to allow immediate consultations to be booked in an expedited fashion, and then undertaken in the same way as a consultation scheduled in the future as described immediately below.

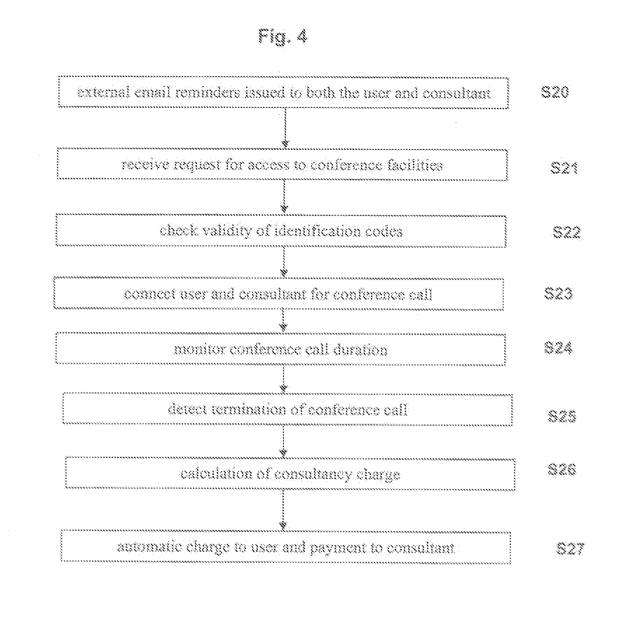

As illustrated in FIG. 4, at a predetermined time interval (e.g. 1 hour, or 24 hours, etc) ahead of each scheduled appointment the messaging manager interacts with the appointments manager 12 to send an automatic message to both the user's and the consultant's external email addresses reminding them of the details of the forthcoming appointment, S20.

If the appointment is scheduled to take place by phone, the parties dial in to the telephony system S21. The communications server 10 then requests the appointment identification code from each party and interfaces with the appointments system to check the validity of the identification codes which are entered S22. The telephony system interfaces with other aspects of the management system 1 to achieve this, and can provide dynamic details, in real-time, to users who dial in beyond simple validity (e.g. ‘your pin is valid, but your call is not yet scheduled to begin; or ‘your pin is valid, but your consultation has expired’). Another aspect of the system with which the telephony system interfaces at this point include users' and consultants' recording preferences, as selected on an individual basis for each call by the participants using the management system (as described earlier). Where the consultation is a telephone consultation and all identification codes are valid, the communication server 10 then connects the parties S23 in a conference space, having given customised verbal responses based on the participants' recording preferences (recorded by the management system) and other particulars.

If the appointment takes place online, the parties log in to the management system 1 and elect to join an internet-based interaction S23. The management system 1 interfaces with the appointments manager 12, recognising the user or consultant who has logged in and his or her pending appointment, and automatically joins the individual into a private, online interaction with the other party. In addition to the textual (type chat), audio (VOIP) and video (VOIP) data which may be exchanged during an online consultation, the communication server 10 additionally provides a shared online interactive workspace which may be in the form of or include a virtual whiteboard on which parties may write, draw or paste images, and which may involve shared documents, interactive tools such as an equation editor, media such as but not limited to a store of pictures held on behalf of the consultant which may be accessed during the conference event etc.

Also, the communication server 10 provides the functionality for documents to be shared and exchanged during the online consultation.

Furthermore, as mentioned earlier the server 10 is optionally adapted to record all interactions which take place through the online conferencing facilities. As with telephone-based consultations, these recordings are then made available by the management system 1 as any conventional audio/video file, e.g. MP3, to both the user and the consultant. The recordings are made available immediately and are accessible via the management system 1.

For both telephone-based and online consultations, the communication server 10 monitors and establishes for how long the consultation participants interacted S24. Recording the time at which each party dialled in (for telephone consultations) or logged in (for online interactions) is insufficient, since parties may subsequently leave the consultation and re-enter. Therefore, ideally, the communication server 10 monitors any times at which any party enters or leaves the consultation and calculates the total time for which they overlapped.

The advice provider or consultant's per-minute billing fee per topic forms part of the account information stored in the consultant accounting store 9e, and will have formed part of the biographical information submitted to the management system by the consultant and visible to users. If a consultant has multiple potential fees, for example involving different fees for different sub-topics, the fee for a particular consultation will have been formally specified by the consultant when proposing an appointment via the management system's messaging system. Once the consultation has been terminated S25, the time for which the parties overlapped on the consultation is multiplied by the consultant's billing rate for that call (since consultants may specify different fees depending on the topic of discussion or other factors) to determine automatically the cost of the consultancy services S26. The cost of e.g. five minutes of the consultant's time may be deducted from the overall cost to provide a ‘grace period’ in which the call participants may exchange introductory information and ensure their comfort with one another.

The management system 1 then bills this cost to the user's pre-arranged conference account which may be a credit card, whose details are entered by the user upon registering with the site and stored in user conference account store 9d. The charge for the consultant's time may be debited from just one user's account even when there are multiple users involved in the conference event. Alternatively, where there are multiple users, each user may be charged separately for their presence at the virtual conferencing event. The cost of the consultancy services is billed independently of any charges the user may incur in accessing the conferencing event. For example, where the conferencing event is a telephone conference, the costs to the user of the call as billed to them by their utility service provider are wholly separate from the charge for the consultancy services. Having registered their credit card details the user is not able to prevent or in any way interfere with the charge being billed to their credit card. The management system 1 is also adapted to enable users to purchase transferable vouchers. These can be given to others who may then use the online management service with the costs of any advice or information they obtain through the online management service being charged against their voucher. The vouchers may be in the form of promotional codes. Additionally, the promotional codes may be used to download for free documents and other material which would otherwise incur a charge. The user will additionally have the option of making payments to the management system which are recorded as credits in the user's accounts details and against which charges for consultancy services and document downloads etc. may be made by the management system.

The management system immediately and automatically transfers this payment to the consultant, using pre-arranged payment facilities, e.g. PayPal™. A charge to the consultant, for use of the management system, is also made. At a pre-determined interval—e.g. every 2 weeks—the management system 1 (using information stored in the consultant account store 9e) calculates the fees earned by consultants from live consultations and the downloading of their written materials by consumers, and charges the consultant's credit card (details of which are stored upon registration in consultant account store 9e) for a proportion of the consultant's gross sales. Monitoring systems on the management system ensure a user is not permitted to make an appointment with a consultant unless the user creates a recognised automated payment arrangement. Similarly, if the management system cannot recover the fees due from consultants when due, the consultant will lose the ability to undertake consultations on the management system and written materials they have made available for sale are suspended by the management system.

It will, of course, be understood that the communication server 10 may be adapted to offer either or both audio only and video and audio conference call facilities. Moreover, any suitable proprietary VOIP service or alternative communications facility may be implemented by means of the management system whilst avoiding the need for either the user or the consultant to install dedicated software on their local terminals. In general, the management system 1 provides an active server pages (ASP)-type remote service for both the user and the consultant: the local terminals 3 of the user and the consultant operating as otherwise dumb terminals.

An additional feature of the message manager 11 of the management system is the ability for a user to contact consultants anonymously in specified circumstances. The administrators of the management system may elect to allow, in certain defined circumstances, users to contact consultants without their name or other identifying information about the user being revealed to the consultant. This is in contrast with messages normally sent within the system where the identity of the user is included.

Relevant circumstances may include, but are not limited to, where contact is made for help in a particular topic which is highly sensitive. In this situation the management system replaces in all communication exchanges the details of the user seen by the consultant with a random—but consistent for the duration of their exchanges—identification number or the like.

Although the preferred means of communication is by means of a telephone- or internet-based live interaction, the management system 1 may additionally provide means for a consultant to provide billable advice using the management system's messaging manager 11. The messaging manager 11 allows a user to send an alternative format of message to a consultant, specifying they wish for advice via message. The messaging system 11 provides a message format which allows a user to specify the topic in which he would like advice, and a maximum charge he is willing to pay. The management system 1 then adopts one of a plurality of possible methodologies when informing the user and consultant of the likely volume of information—or the time commitment—to which the consultant should commit in addressing the question via a message. Which methodology the system 1 uses is determined by the party deploying the management system. The preferred approach is as follows: an estimate of the time the consultant should commit to the answer is automatically calculated by the management system by dividing the maximum amount the user is willing to pay (as specified in the message) by the consultant's per-minute fee stored in the consultant account data store 9e. This information is displayed dynamically to the user as he enters a maximum fee in his message request, before it is sent, and enables the user to see immediately the commitment of time the consultant will be expected to make. The management system 1 may also make adjustments, for example increasing the length of time it is indicated a consultant should spend given the payment limit the user specified, to reflect the fact that advice provided via message may be less valuable than that given in a live consultation due to the lack of available interaction during the provision of the advice.

While the preferred means of communication is via live consultations, the management system 1 offers an additional capability in the form of multi-user ‘events’. These events involve multiple consumers, rather than a single individual, joining a telephone- or web-based consultation or presentation. For example, 500 consumers may dial or log in to an event to listen and/or see a parenting expert discuss how to help a child sleep more soundly through the night. The management system 1 is adapted to enable a consultant to specify a date, time, topic, cost, description and medium for an event. Just as the management system 1 allows users to browse or search for consultants offering one-to-one calls and their materials available for download, the system 1 may also interface with the database 9 to determine and display relevant forthcoming events which match search criteria. Furthermore, the management system 1 allows users to specify their intention to join an event. Information about the number of likely participants is also available for the consultant offering the event to view. The management system 1 interacts with the telephony and web-based systems to ensure that for telephone or other online events, all participants except the host are muted for a period of, or the duration of, the call. The management system and messaging system, however, may offer the capability for users who have joined an event to submit questions via the messaging system, which will appear immediately on the screen of the consultant offering the consultation. The consultant may then elect to address questions they have received in an orderly fashion.

As mentioned earlier, the management system 1 may include a document manager which is adapted to enable a consultant to upload materials (documents and files) that may be downloaded either for free or for a charge by users. Uploading a document to the management system website is conventional in operation and results in a copy of the document being stored in the publications data store 9c. An abstract about each document may, additionally, be provided by the consultant and the consultant is able to assign a charge to be made again any user downloading the document. Similarly, downloading a document from the management system website is conventional in operation and is not described in detail. To allow for hardware damage or software problems, a user is able to download the same document more than once without an additional charge being made, but repeated downloading is limited for example to three occasions.

Optionally, the management system 1 enables consultants to automatically view the charges of other consultants in order to determine an appropriate charge for their own time and for their documents. Moreover, the management system 1 additionally provides a mechanism for enabling users to rate the performance of consultants available on the website and their documents. The methodology and the software instructions for enabling ratings to be posted by users and accumulated is conventional in operation and so is not described in detail.

The management system described herein is adapted for the provision of advice and services online. It enables members of the public to receive advice and information, in real-time, as well as downloadable materials, from highly qualified experts in a wide range of topics including—but not limited to—education, finance, parenting, careers, law, business development, skills, technology and computing, writing, personal development, health and well-being etc. The management system enables consumers to browse a directory of experts and enables a live consultation with their chosen expert based on a pre-agreed charging regime. Thus, with the management system described herein it is possible for consumers to find and receive personalised, interactive, nuanced help and guidance which addresses their unique and complex real-life problems and questions. In addition, the management system allows: consultants to upload, price and categorise materials which consumers may then pay to download; users to solicit, receive and pay for information via the asynchronous transfer of messages; and ‘multi-party events’ (consultations by phone or online in which many participant users receive information at once).

Although the management system has been described in relation to a website facilitating consultancy services, it will be apparent that the management system is equally relevant to other types of personal services available on-line. For example, the management system may be used as part of a legal services billing system. Also, the management system may be used as part of an online dating service, as a system for the location and distribution of written materials and media such as equity/economic research products, the provision of adult material, or a personal entertainment service involving the interaction between two or more people remotely.

A further application of the management system is as a ‘knowledge management’ solution for organisations and companies. Large companies today typically contain employees who have significant expertise regarding specific projects, companies, products, processes, programs, experiences, best practices, tools and so forth. Such companies are often geographically disparate, with employees spanning multiple campuses or countries and many larger companies now employ internal accounting in which services provided between different departments of a large company generate notional charges which can be used as a measure of department economics. Typically, much of the employees' information, resources and experience goes wasted since other employees will be unaware it exists within the minds—or on the hard disk drives—of other employees in the organisation. The management system described herein would serve well as an internal (only) knowledge management tool within such companies.

Individual employees may have profiles which describe their expertise and experiences, to be found easily by other employees facing similar challenges or tasks. The uploading and distribution of categorised and searchable materials and media would also be of value in this context.

The above describes a preferred implementation of the management system. A person of ordinarily skill in the art will appreciate that there are alternative implementations which do not depart from the spirit or scope of the present invention. For example, the functionality described above as being provided by a remote server may alternatively be provided by a plurality of remote servers or some of the functionality may alternatively be provided by software installed on the local terminals. The scope of the present disclosure should therefore be taken to encompass any novel feature or combination of features or equivalents thereof, which are disclosed herein, either explicitly or implicitly, or any generalisation thereof.

What we claim is:

1. An online management method for the provision of advice and services, the method comprising the steps of:
receiving requests from a plurality of participants including an advice provider and at least one user for access to a conferencing event in which the advice provider is to provide advice, services or advice and services to the at least one user in return for a fee;
receiving from the at least one user a user specified maximum fee;
calculating automatically a maximum time duration the advice provider should participate in the conferencing event on the basis of the user specified maximum fee and the advice provider's predetermined cost per unit time;
checking the identity of each participant;
establishing a conferencing space in which each participant is able to communicate with each other participant and communicating the calculated maximum time to each participant; and thereafter automatically debiting from at least one of the at least one users using a pre-arranged account a charge for the conferencing event, wherein the charge is based upon the time duration of the advice provider's participation in the conferencing event, the charge not exceeding the user specified maximum fee in the absence of consent from the user to an increase.

2. An online management method as claimed in claim 1, further comprising the step of adjusting the advice provider's predetermined cost per unit time based upon at least one of: the communication medium used for the conferencing event, the topic of the conferencing event, and the status of the at least one user.

3. A management method as claimed in claim 1, further comprising the step of recording at least one or more of audio, video and other interactions which take place during the conferencing event and providing at least one participant with access to the recording such that the at least one participant can access the recording after the conferencing event.

4. An online management method as claimed in claim 1, further comprising the step of separately monitoring the duration of the advice provider's and the user's participation in a conferencing event and determining the charge for the user on the basis of the simultaneous participation of the advice provider and the user in the conferencing event.

5. An online management method as claimed in claim 1, wherein during a conferencing event involving more than one user, the duration of each user's participation in the conferencing event is separately recorded and a charge for each individual user is determined on the basis of the duration of the simultaneous participation of the advice provider and the individual user and billed to the individual user's pre-arranged account.

6. An online management method as claimed in claim 1, further comprising the step of allocating a conferencing slot in response to a request from at least one of the participants, wherein the step of allocating a conferencing slot is adapted to enable mutual agreement between the participants of one or more of a time for commencement of the conferencing slot, a topic for the conferencing slot, and the fee for the conferencing slot.

7. An online management method as claimed in claim 1, wherein a payment is rendered to the advice provider based upon the total charges debited from the at least one users' pre-arranged accounts less an administrative charge retained by the conference space provider.

8. An online management method as claimed in claim 1, comprising the exchange of one or more messages between the advice provider and the one or more users and automatically debiting, from the user's pre-arranged account, a charge for the exchange of one or more messages wherein the charge is either calculated on the basis of the advice provider's predetermined cost per unit time and the time duration for the preparation of each message issued by the advice provider or is a calculated on the basis of a fixed fee for each message.

9. An online management method as claimed in claim 1, further comprising the steps of enabling the downloading of material in the form of documents or other media and automatically debiting from a user's pre-arranged account a charge for the downloaded material.

10. An online management method as claimed in claim 1, wherein only a pre-approved advice provider is allowed to participate in the conferencing event.

11. An online management method as claimed in claim 1, wherein an advice provider is allowed to compare their cost per unit time fee with another advice provider's cost per unit time fee.

12. An online system for the provision of advice and services, the system comprising:
a memory in which is stored a participant database containing details of participants to a conferencing event the participants comprising an advice provider and at least one user;
a processor for calculating automatically a maximum time duration the advice provider should participate in the conference event based on a user specified maximum fee and the advice provider's predetermined cost per unit time;
a conferencing server in communication with the participant database for checking the identity of each participant to the conferencing event and for establishing a conferencing space in which each participant is able to communicate with each other participant; and
a billing manager adapted to automatically debit from at least one of the at least one users using a pre-arranged account a charge for the conferencing event, the charge being based upon the time duration of the advice provider's participation in the conferencing event and the charge not exceeding the user specified maximum fee in the absence of consent from the user to an increase.

13. The online system of claim 12, wherein the advice provider's predetermined cost per unit time varies with respect to at least one of: the communication medium used for the conferencing event, the topic of the conferencing event, and the status of the at least one user.

14. The online system of claim 12, further comprising a display driver for generating image data for displaying to the participants, the image data including the calculated maximum time duration the advice provider should participate in the conferencing event.

15. The online system of claim 12, further comprising a recorder adapted to record one or more of audio, video and other interactions which take place during a conferencing event for later access by at least one participant of the conferencing event.

16. The online system of claim 12, further comprising a timer adapted to separately monitor the duration of the advice provider's and the user's participation in a conferencing event whereby the billing manager determines a charge for the user on the basis of the simultaneous participation of the advice provider and the user in the conferencing event.

17. The online system of claim 12, further comprising a timer adapted to separately monitor the duration of each user's participation in the conferencing event involving more than one user wherein a charge for each individual user is determined on the basis of the duration of the simultaneous participation of the advice provider and the individual user and billed to the individual user's pre-arranged account.

18. The online system as claimed in claim 12, further comprising an appointments manager for allocating a conferencing slot in response to a request from at least one of the participants, the appointments manager being adapted to enable mutual agreement between the participants of one or more of a time for commencement of the conferencing slot, a topic for the conferencing slot, and the fee for the conferencing slot.

19. The online system as claimed in claim 12, wherein the system includes a message manager adapted to enable message exchange between the advice provider and the one or more users and wherein the billing manager is adapted to automatically debit from the one or more users' pre-arranged account a charge for the message exchange.

20. The online system as claimed in claim 12, wherein the system further includes a document manager adapted to enable the downloading of material in the form of documents or other media and wherein the billing manager is adapted to automatically debiting from a user's pre-arranged account a charge for the downloaded material.
